(19) United States
(12) Patent Application Publication
(10) Pub. No.: US 2025/0295118 A1
(43) Pub. Date: Sep. 25, 2025

(54) PEST CONTROL COMPOSITIONS

(71) Applicants: Dow Global Technologies LLC, Midland, MI (US); Rohm and Haas Company, Collegeville, PA (US)

(72) Inventors: Caroline Woelfle-Gupta, Midland, MI (US); Selvanathan Arumugam, West Chester, PA (US); Yujing Tan, Midland, MI (US)

(21) Appl. No.: 18/863,125

(22) PCT Filed: May 31, 2022
(86) PCT No.: PCT/US2022/031537

§ 371 Date: Nov. 5, 2024

(51) Int. Cl. A01N 63/23; A01N 65/00; A01P 7/04

(52) U.S. Cl. CPC A01N 63/23; A01N 65/00; A01P 7/04

(57) ABSTRACT

A pest control composition includes humic acid, wherein the humic acid has a concentration of phenolic groups of 0.19 to 1.30 millimoles per gram of the humic acid, bacillus thuringiensis and water.

### FIELD OF DISCLOSURE

The present disclosure relates to pest control compositions, and specifically to pest control compositions comprising bacillus thuringiensis.

### BACKGROUND

Pest control agents are utilized to control pests, such as insects. The effectiveness of pest control agents can be influenced by a number of factors. There is continued focus in the industry on providing new and improved pest control compositions.

### SUMMARY

According to a first feature of the present disclosure, a pest control composition includes humic acid, wherein the humic acid has a concentration of phenolic groups of 0.19 to 1.30 millimoles per gram of the humic acid, bacillus thuringiensis, and water. According to a second feature of the present disclosure, the humic acid is from 0.1 wt % to 5.0 wt % of the pest control composition based upon a total weight of a combination of the humic acid, the bacillus thuringiensis, and the water. According to a third feature of the present disclosure, the water is from 25.00 wt % to 99.89 wt % of the composition based upon the total weight of the humic acid, the bacillus thuringiensis, and the water. According to a fourth feature of the present disclosure, the humic acid has a concentration of phenolic groups of 0.375 to 1.26 millimoles per gram of humic acid.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated. Subscript values in polymer formulae refer to mole average values for the designated component in the polymer.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, a “wt %” or “weight percent” or “percent by weight” of a component, unless specifically stated to the contrary, is based on the total weight of the composition or article in which the component is included. As used herein, all percentages are by weight unless indicated otherwise.

Pest control compositions and methods are disclosed herein. Embodiments of the present disclosure provide that the pest control compositions and methods include humic acid, bacillus thuringiensis, and water.

The pest control compositions disclosed herein may be applied to plants, e.g., plant surfaces, to control pests. Advantageously, the pest control compositions disclosed herein can provide an improved, i.e., greater, remaining bacteria viability following exposure to light, e.g., sunlight, as compared to other formulations. In other words, the pest control compositions disclosed herein can provide an improved UV stability, as compared to other formulations. This improved remaining bacteria viability can help provide that the pest control compositions disclosed herein can provide greater pest control, as compared to other formulations having a relatively lesser remaining bacteria viability following exposure to light. Surprisingly, utilizing the humic acid having a phenolic group concentration of 0.19 to 1.30 millimoles per gram of humic acid provides an improved remaining bacteria viability following exposure to light, as compared to other formulations including humic acid having a lesser phenolic group concentration.

The pest control compositions disclosed herein include humic acid having a phenolic group concentration of 0.19 to 1.30 millimoles per gram of humic acid. As used herein, “phenolic group” refers to an aromatic hydrocarbon group directly bonded to one or more hydroxyl groups. Humic acid is an acidic organic polymer that can be extracted from humus found in soil, sediment, or aquatic environments. Humic acid is identified by the Chemical Abstracts Service (CAS) number 1415-93-6. Humic acid may be obtained commercially from various suppliers. Examples of commercially available humic acid include, but are not limited to, products available from Sigma-Aldrich, or Fisher Scientific.

One or more embodiments of the present disclosure provide that the humic acid may be a solid, e.g., that is incorporated into the pest control compositions disclosed herein. One or more embodiments of the present disclosure provide that the humic acid may be a mixture, e.g., a mixture of humic acid and a liquid such as water, that is incorporated into the pest control compositions disclosed herein. One or more embodiments of the present disclosure provide that the humic acid may be a solution, e.g., a solution of humic acid in a liquid such as water that is incorporated into the pest control compositions disclosed herein. Combinations of solids, mixtures, and solutions may be utilized. The humic acid may have various pH values for various applications.

One or more embodiments provide that the humic acid is processed humic acid. As used herein, “a processed humic acid” refers to humic acid that has undergone a chemical procedure to extract humic acid from humus, e.g., the soil organic matter.

Various chemical procedures utilized to extract the humic acid can provide different compositional make-ups of extracted humic acids. Extraction procedures can be varied to yield a desired composition, e.g., a particular phenolic group concentration. However, as disclosed herein, there has surprisingly been found a correlation between the compositional make up of humic acid and the technical effect of providing an improved remaining bacteria viability following exposure to light. Surprisingly, humic acid having a phenolic group concentration from 0.19 to 1.30 millimoles per gram of humic acid have found to provide improved remaining bacteria viability following exposure to light while, other humic acids, e.g., that have phenolic group content less than 0.19 millimoles per gram of humic acid are not effective in providing improved remaining bacteria viability following exposure to light. One or more embodiments provide that the pest control compositions can include fulvic acids and/or other humus components, e.g., that may result from the humic acid extraction procedure.

One or more embodiments provide that the humic acid is soluble or dispersible in water. Processes utilized to provide that the humic acid dispersible or soluble in water, can decrease the phenolic group concentration of the humic acid.

One or more embodiments of the present disclosure include determining a phenolic group concentration of the humic acid. The phenolic group concentration of the humic acid may be determined using known equipment and processes. For instance, the phenolic group concentration of the humic acid may be determined by absorbance analysis. As an example, the humic acid to be analyzed may be added to an assay solution to provide a colored complex, e.g., via reduction of one of the assay components and a subsequent complexation of the reduced component with another component present in the assay solution to yield a colored complex. Then, the colored complex may be utilized for absorbance analysis. Humic acid determined to have a phenolic group concentration from 0.19 to 1.30 millimoles per gram of humic acid may be utilized with the embodiments disclosed herein. The humic acid may have a phenolic group concentration of from 0.10 millimoles per gram of humic acid to 1.50 millimoles per gram of humic acid as determined according to the procedure laid out in the Examples section below. For example, the humic acid may have a phenolic group concentration in millimoles per gram of humic acid of 0.10 or greater, or 0.20 or greater, 0.30 or greater, or 0.40 or greater, or 0.50 or greater, or 0.60 or greater, or 0.70 or greater, or 0.80 or greater, or 0.90 or greater, or 1.00 or greater, or 1.10 or greater, or 1.20 or greater, or 1.30 or greater, or 1.40 or greater, while at the same time, 1.50 or less, or 1.40 or less, or 1.30 or less, or 1.20 or less, or 1.10 or less, or 1.00 or less, or 0.90 or less, or 0.80 or less, or 0.70 or less, or 0.60 or less, or 0.50 or less, or 0.40 or less, or 0.30 or less, or 0.20 or less.

Determining the phenolic group concentration of the humic acid, as previously discussed and/or other analytical methods can be used to determine phenolic content of humic acids and subsequently used to provide a chemical procedure that yields humic acid having the desired phenolic content concentration, i.e. from 0.19 to 1.30 millimoles per gram of humic acid. One or more embodiments provide that one or more components may be excluded from extraction. For instance, phenol blocking agents, crosslinking, and oxidizing can be excluded from extraction media. A number of components and/or conditions may be preferred for extraction. For instance, reducing agents for quinone, chemical reagents, and elevated temperature to cleave phenolic ethers can be utilized for the extraction. Additionally, an extract media composition can be designed to include a solvent mix that is higher portioned for phenolic compounds.

The pest control compositions disclosed herein include bacillus thuringiensis. As defined herein, “bacillus thuringiensis” is the spores and/or the crystallized proteins of the species bacillus thuringiensis and includes all bacillus thuringiensis subspecies exhibiting insecticidal properties. Examples of such subspecies include kurstaki, israelensis and aizawa. The bacillus thuringiensis may be added to the pesticide formulation as either a solid or as part of a liquid formulation. The presence and subspecies of bacillus thuringiensis is determined by Random Amplified Polymorphic DNA analysis. A commercially available liquid formulation of bacillus thuringiensis is THURICIDE™ pesticide available from CERTIS USA, Columbia, Maryland.

A greater remaining bacteria viability, following exposure to light, can provide desirably improved pest control, as compared to other formulations.

One or more embodiments of the present disclosure provide that the pest control compositions disclosed herein can include an additive. Examples of additives include viscosity modifiers, pH modifiers, herbicides, fungicides, and combinations thereof, among others. Different amounts of the additive may be utilized for various applications.

The pest control compositions disclosed herein can include from 0.1 wt % to 50.0 wt % of the humic acid based upon a total weight of a combination of the humic acid, the bacillus thuringiensis, and the water. For example, the pest control composition may comprise 0.1 wt % or greater, or 0.2 wt % or greater, or 0.4 wt % or greater, or 0.6 wt % or greater, or 0.8 wt % or greater, or 1.0 wt % or greater, or 1.2 wt % or greater, or 1.4 wt % or greater, or 1.6 wt % or greater, or 1.8 wt % or greater, or 2.0 wt % or greater, or 2.2 wt % or greater, or 2.4 wt % or greater, or 2.6 wt % or greater, or 2.8 wt % or greater, or 3.0 wt % or greater, or 3.2 wt % or greater, or 3.4 wt % or greater, or 3.6 wt % or greater, or 3.8 wt % or greater, or 4.0 wt % or greater, or 4.2 wt % or greater, or 4.4 wt % or greater, or 4.6 wt % or greater, or 4.8 wt % or greater, or 5.0 wt % or greater, or 10 wt % or greater, or 20 wt % or greater, or 30 wt % or greater, or 40 wt % or greater, while at the same time, 50 wt % or less, or 40 wt % or less, or 30 wt % or less, or 20 wt % or less, or 10 wt % or less, or 5 wt % or less, or 4.8 wt % or less, or 4.6 wt % or less, or 4.4 wt % or less, or 4.2 wt % or less, or 4.0 wt % or less, or 3.8 wt % or less, or 3.6 wt % or less, or 3.4 wt % or less, or 3.2 wt % or less, or 3.0 wt % or less, or 2.8 wt % or less, or 2.6 wt % or less, or 2.4 wt % or less, or 2.2 wt % or less, or 2.0 wt % or less, or 1.8 wt % or less, or 1.6 wt % or less, or 1.4 wt % or less, or 1.2 wt % or less, or 1.0 wt % or less, or 0.8 wt % or less, or 0.6 wt % or less, or 0.4 wt % or less, or 0.2 wt % or less of humic acid based on the total weight of the pest control composition.

The pest control compositions disclosed herein can include from 0.01 wt % to 25.00 wt % of the bacillus thuringiensis, based upon a total weight of a combination of the humic acid the bacillus thuringiensis, and the water. All individual values and subranges from 0.01 wt % to 25.00 wt % are included; for example, the pest control composition can include the bacillus thuringiensis from a lower limit of 0.01 wt %, 0.03 wt %, 0.05 wt %,

0.08 wt %, or 1.00 wt % to an upper limit of 25.00 wt %, 15.00 wt %, 10.00 wt %, 5.00 wt %, or 4.50 wt % based upon the total weight of the combination of the humic acid, the bacillus thuringiensis, and the water.

The pest control compositions disclosed herein can include from 25.00 wt % to 99.89 wt % of water, based upon a total weight of a combination of the humic acid, the bacillus thuringiensis, and the water. All individual values and subranges from 25.00 wt % to 99.89 wt % are included; for example, the pest control composition can include the water from a lower limit of 25.00 wt %, 50.00 wt %, 65.00 wt %, 75.00 wt %, 80.5 wt % to an upper limit of 99.89 wt %, 99.47 wt %, 98.95 wt %, 96.92 wt % or 94.00 wt % based upon the total weight of the combination of the humic acid, the bacillus thuringiensis, and the water.

The pest control compositions disclosed herein can be formed using known equipment and processes. The components of the pest control compositions may be combined, e.g., mixed, to form the pest control compositions. For instance, the components of the pest control compositions may be added to a vessel and be agitated therein. The components of the pest control compositions may be combined in any order.

The pest control compositions disclosed herein may be applied to plants, e.g., plant surfaces, to control pests. The pest control compositions may be applied to plants using known equipment and processes. For instance, the pest control compositions may be sprayed, sprinkled, and/or poured, among other applications, to plants. Different amounts of the pest control composition may be applied to plants for various applications.

The pest control compositions may be applied to plants using known equipment and processes. For instance, the pest control compositions may be sprayed, sprinkled, and/or poured, among other applications, to plants. Different amounts of the pest control composition may be applied to plants for various applications.

The components of the pest control compositions may be combined in any order. For instance, the humic acid may be combined with bacillus thuringiensis and subsequently the combination of the humic acid and the bacillus thuringiensis may be combined with the water. The humic acid may be combined with water and subsequently the combination of the humic acid and the water may be combined with the bacillus thuringiensis. The bacillus thuringiensis may be combined with water and subsequently the combination of the bacillus thuringiensis and the water may be combined with the humic acid. The humic acid, the bacillus thuringiensis, and the water may be combined simultaneously.

One or more embodiments of the present disclosure are directed toward a method for pest control. The method can include applying a pest control composition to plants, e.g., plant surfaces, to control pests. The method can include applying a pest control composition that includes humic acid, the bacillus thuringiensis; and water to a plant. As discussed, advantageously the pest control compositions disclosed herein can provide an improved, i.e., greater, remaining bacteria viability following exposure to light, e.g., sunlight, as compared to other formulations.

### EXAMPLES

In the Examples, various terms and designations for materials are used including, for instance, the following:

Humic acid-1 (humic acid, solution with 5.2 wt % solids, pH 9.2); humic acid-2 (humic acid, solution with 4.8 wt % solids, pH 5.4); humic acid-3 (humic acid, solution with 6.0 wt % solids, pH 8.8); humic acid-4 (humic acid, solid, pH 9.1, as determined with 2.5 wt % humic acid-4 solution); humic acid-5 (humic acid, solid, pH 9.3, as determined with 2.5 wt % humic acid-4 solution); humic acid-6 (humic acid, solution with 5.6 wt % solids, pH 8.5); humic acid-7 (humic acid, solution with 4.4 wt % solids, pH 8.6); humic acid-8 (humic acid, solution with 0.6 wt % solids, pH 8.2); THURICIDE™ bacillus thuringiensis formulation (pest control agent, liquid formulation, bacillus thuringiensis, manufactured by CERTIS).

Humic acid-polyol blend was formed as follows. Humic acid (48.6 grams, solid humic acid obtained from SIGMA-ALDRICH™) and approximately 10 wt % potassium hydroxide were heated to 150° C. in a Parr reactor. Ethylene oxide (888.2 grams) was heated and was added to the contents of the reactor at an addition rate of approximately 0.5 to 1.0 g/min, during which the reactor pressure increased. The ethylene oxide addition was started and stopped several times over the addition. After approximately 115 grams of the ethylene oxide had been added, the reactor pressure dropped significantly, with a corresponding output of heat; the cooling water increased to maintain the temperature. The addition rate was increased over time approximately 4 g/min, with minimal pressure increase in the reactor. After approximately 494 grams of the ethylene oxide had been added, the addition rate was decreased to 1 g/min for the remainder of the addition. When the ethylene oxide addition was complete, the reactor contents were cooled to 80° C., and the reactor was vented and purged with nitrogen. The reactor bottom valve was opened, and 53.7 grams of black liquid was collected and discarded, and the bottom valve was closed. The remaining reactor contents solidified upon cooling; 530 mL of DI water was added to the contents of the reactor to provide the humic acid-polyol blend. 1361.8 grams of the humic acid-polyol blend was removed from the reactor.

Example 1, a method of forming a pest control composition was performed as follows. Determining the phenolic group concentration per gram of humic acid, was performed as follows; after determining the concentration, humic acid having a concentration of phenolic groups of 0.19 to 1.30 millimoles per gram of humic acid was combined with a pest control agent to form pest control compositions. Humic acid solutions (0.1 wt % humic acid) were prepared by respectively combining each of humic acid-1, humic acid-2, humic acid-3, humic acid-4, humic acid-5, humic acid-6, humic acid-7, humic acid-8, humic acid-polyol blend and water. An aliquot of each humic acid solution was respectively combined with an assay solution; the assay solution contained 4% cupric sulfate solution (excess of Cu²⁺ salt; CAS 7758-99-8; Purchased from THERMO FISHER™; Product #23224), and bicinchoninic acid (CAS 1245-13-2; obtained from MILLIPORE SIGMA™; Product #B9643). Phenolic groups reduced the Cu²⁺ to Cu+ and formed a purple colored complex with the bicinchoninic acid; the concentration of formed complex was determined colorimetrically by measuring absorbance at 562 nm using a VARIAN CARY™ 50 UV-Vis spectrophotometer. From the concentration of the Cu+-BCA, the concentration of phenolic groups in the humic acids were determined using hydroquinone as the calibration standard; the linear calibration curve with hydroquinone plotted absorbance on the y-axis vs. nanomoles of phenolic groups on the x-axis, where y=0.0104× and R-squared=0.9989. The phenolic group concentration was determined as nanomoles of phenol in the aliquot and the dilution factor and humic acid mass was used to convert the nanomoles to millimoles/g of humic acid. The results are reported in Table 1.

Example 2, a pest control composition, was formed as follows. Humic acid-1 solution (0.28 mL; 2.5 wt % humic acid in water) and THURICIDE™ bacillus thuringiensis formulation (9.72 mL; 7.35 wt % bacillus thuringiensis) were added to a container and mixed with a magnetic stir bar to provide Example 2.

Example 3, a pest control composition, was formed as Example 2 with the change that humic acid-2 (0.28 mL; 2.5 wt % humic acid in water) was utilized rather than the humic acid-1.

Example 4, a pest control composition, was formed as Example 2 with the change that humic acid-3 (0.28 mL; 2.5 wt % humic acid in water) was utilized rather than the humic acid-1.

Example 5, a pest control composition, was formed as Example 2 with the change that humic acid-4 (0.28 mL; 2.5 wt % humic acid in water) was utilized rather than the humic acid-1.

Example 6, a pest control composition, was formed as Example 2 with the change that humic acid-5 (0.28 mL; 2.5 wt % humic acid in water) was utilized rather than the humic acid-1.

Comparative Example A was formed as Example 2 with the change that humic acid-6 was (0.28 mL; 2.5 wt % humic acid in water) was utilized rather than the humic acid-1.

Comparative Example B was formed as Example 2 with the change that humic acid-7 was (0.28 mL; 2.5 wt % humic acid in water) was utilized rather than the humic acid-1.

Comparative Example C was formed as Example 2 with the change that humic acid-8 was (0.28 mL; 2.5 wt % humic acid in water) was utilized rather than the humic acid-1.

Comparative Example D was formed as Example 2 with the change that humic acid-polyol blend was (0.28 mL; 2.5 wt % humic acid in water) was utilized rather than the humic acid-1.

Comparative Example E was formed as Example 2 with the change that the humic acid-1 was not utilized.

Remaining bacteria viability following exposure to light for Examples 2-6 and Comparative Examples A-E were determined as follows.

Approximately 3 grams of Examples 2-6 and Comparative Examples A-E were respectively used for each sample; the materials were spread on respective plastic petri dishes and dried for approximately 1 hour. The samples were exposed to light at 35 milliwatts/cm² for 2 hours. For extraction, each of the samples was placed in 1 wt % solution of TWEEN™ 20 solution and incubated for approximately 12 hours. For plating, the samples were diluted to a desired starting concentration, using a 0.1 wt % solution of TWEEN™ 20 then serially diluted at suitable concentrations and plated evenly in 10 μL drops. The plates were then held in an incubator at 30° C. for approximately 12 hours. The number of colonies before and after light exposure were counted to determine the remaining bacteria viability after exposure to light. The results are reported in Table 1.

TABLE 1

| | Phenolic group | Remaining |
|---|---|---|
| | concentration | bacteria viability |
| | (millimoles per gram | (%) after light |
| | of humic acid) | exposure |
| Example 2 | 0.423077 | 87 |
| Example 3 | 0.394231 | 83 |
| Example 4 | 1.259615 | 91 |
| Example 5 | 0.192308 | 61 |
| Example 6 | 0.375000 | 78 |
| Comparative | 0.096154 | 0 |
| Example A | | |
| Comparative | 0.038462 | 0 |
| Example B | | |
| Comparative | 0.009615 | 0 |
| Example C | | |
| Comparative | 0.019231 | 0 |
| Example D | | |
| Comparative | — | 0 |
| Example E | | |

The data of Table 1 illustrates that each of Examples 2-6 have an improved remaining bacteria viability after light exposure as compared to each of Comparative Examples A-E.

1. A pest control composition comprising:
humic acid, wherein the humic acid has a concentration of phenolic groups of 0.19 to 1.30 millimoles per gram of the humic acid;
bacillus thuringiensis; and
water.

2. The pest control composition of claim 1, wherein the humic acid is from 0.1 wt % to 5.0 wt % of the pest control composition based upon a total weight of a combination of the humic acid, the bacillus thuringiensis, and the water.

3. The pest control composition of any one of claim 1, wherein the water is from 25.00 wt % to 99.89 wt % of the composition based upon the total weight of the humic acid, the bacillus thuringiensis, and the water.

4. The pest control composition of any one of claim 1, wherein the humic acid has a concentration of phenolic groups of 0.375 to 1.26 millimoles per gram of the humic acid.
